(19) United States
(12) Patent Application Publication
(10) Pub. No.: US 2010/0034190 A1
(43) Pub. Date: Feb. 11, 2010

(54) Apparatus for wireless communication and method for synchronizing time thereof

(75) Inventors: Sang-jun Yun, Daejeon (KR); Hyun-myung Lee, Daejeon (KR)

Correspondence Address: HARNESS, DICKEY & PIERCE, P.L.C., P.O. BOX 828, BLOOMFIELD HILLS, MI, 48303, US

(73) Assignee: Hanyang Navicom Co., Ltd

(21) Appl. No.: 12/082,388

(22) Filed: Apr. 10, 2008

(30) Foreign Application Priority Data
May 17, 2007 (KR) 10-2007-0048195

(51) Int. Cl. H04J 3/06

(52) U.S. Cl. 370/350

(57) ABSTRACT

Disclosed are a wireless communication apparatus and a time synchronization method performed thereby.

### CROSS-REFERENCE TO RELATED APPLICATION

This non-provisional application claims priority under 35 U.S.C §119(a) on U.S. patent application Ser. No. 10-2007-0048195 filed in Korea on May 17, 2007, the entire contents of which are hereby incorporated by reference.

### BACKGROUND OF THE INVENTION

1. Field of the Invention

The present invention relates to an apparatus for wireless communication and a method for synchronizing time thereof, and more particularly to a time display apparatus and a time synchronization method which can provide improved time accuracy by correcting inaccuracy in frequency of an oscillator in the time display apparatus maintaining time, and additionally reduce the consumption of power required for implementing such a function in the time display apparatus.

2. Description of the Prior Art

The conventional time display apparatus receives time-of-day (TOD) information and a time synchronization signal from a time standard reception apparatus, such as WWVB, JJY, DCF77, etc., including a global navigation satellite system (GNSS) wirelessly receiving time information, and then displays time. Meanwhile, when connected by wire, time information is received by means of protocols, such as a simple network time protocol, IEEE1588, etc, and time is displayed.

Among these technologies, the technology (WWVB, JJY, CDF77, etc.) transmitting time information through a long wave band is generally used as a method of receiving standard time within the coverage of a corresponding wave. However, the long wave has a problem in that the long wave is not correctly received indoors or in the case where a receiving clock is installed facing a specific direction due to the characteristics of the long wave. Even in terms of accuracy, although time is well kept directly after the long wave has been received, error increases due to inaccuracy of frequency of an oscillator in a receiver, which keeps time, as time goes by. The radio wave control clock, as described above, receives time information and so on only about twice per day, without constant synchronization, in order to minimize power consumption. If the frequency of synchronizations increases in order to correct time error, which is caused as time goes by after the first synchronization, the consumption of power increases as much as the frequency of synchronizations increases.

The GNSS, which is one of radio schemes, has been developed for global time synchronization and position measurement, and is widely used in various industry fields which require exact time synchronization within a few microseconds. However, since the GNSS uses an ultra-high frequency of GHz band, if an antenna is installed in an area where the sky cannot be seen, it is almost impossible to receive signals from the GNSS. Also, in this case, since only a very weak signal can be received, if it is received at all, it is necessary to amplify the received signal and to process a large amount of calculations for handling the received signal, thereby causing a comparatively large amount of power consumption.

Since the Ethernet-based IEEE 1588 and the SNTP, which is a scheme of transmitting time through the Internet, are based on systems aimed at communication, comparatively complex software and hardware are required. Therefore, when such schemes are applied to a time display apparatus as it is, there is a problem in that many restrictions exist in terms of facility of installation, power consumption, and cost.

### SUMMARY OF THE INVENTION

Accordingly, the present invention has been made to solve the above-mentioned problems occurring in the prior art, and an object of the present invention is to provide a system capable of efficiently and wirelessly transmitting/receiving time by separately constructing a wireless time transmission apparatus and a wireless time display apparatus in order to overcome the limitation of the conventional time display apparatus.

In addition, in order to improve the accuracy of time in a time acquisition and time maintenance method of the wireless time transmission apparatus and wireless time display apparatus in the wireless time transmission/reception system, another object of the present invention is to promote the accuracy of a time synchronization signal transmitted to the wireless time display apparatus by using a frequency correction algorithm in the wireless time transmission apparatus, and to maintain time information having improved accuracy by using another frequency correction algorithm, even in the wireless time display apparatus displaying time.

In accordance with an aspect of the present invention, there is provided An apparatus for wireless communication, comprising: a receiving unit for wirelessly receiving a synchronization signal and time information from a global navigation satellite system; an input unit for input of a set value for setting daylight-saving time and a Greenwich Mean Time offset; a memory for storing the time information and the set value; a processor for correcting an internal reference pulse compared with the synchronization signal, creating a data packet including an internal time information created using the time information and the set value, and transforming the data packet into a data stream in accordance with timing of the internal reference pulse; and a transmitting unit for wirelessly transmitting the data stream.

In an exemplary embodiment of the present invention, the receiving unit wirelessly receives the synchronization signal and the time information from the global navigation satellite system periodically, and the processor sets the time information as the internal time information if the time information and the internal time information, which is created by increasing the time information to a fixed size, are repeatedly same for a fixed number of times when compared with each other.

In an exemplary embodiment of the present invention, the data packet includes a main time packet, a date packet, a clock adjust pending packet and a time offset packet, and the processor transforms the data packet into the data stream allocating a slot to every time offset packet, in which the processor divides a message ID of the time offset packet by a predetermined figure so that gets quotient and remainder, allocates the slot which is to be filled with the time offset packet in order of a value of the quotient, and determines where the time offset packet is located after the clock adjust pending packet in order of a value of the remainder.

In an exemplary embodiment of the present invention, the processor creates the internal time information by applying a leap second if the set value further includes leap second information.

In an exemplary embodiment of the present invention, the apparatus further comprising: a network connection unit for receiving the time information with a wired connection, wherein the processor controls the network connection unit to receive the time information with the wired connection if the receiving unit is not capable of wirelessly receiving the time information.

In an exemplary embodiment of the present invention, the processor includes a transmitting processor and a signal processor, in which the signal processor corrects the internal reference pulse, and the transmitting processor creates the data packet and transforms the data packet into the data stream.

In an exemplary embodiment of the present invention, the signal processor corrects the internal reference pulse by repeatedly calculating an error by comparing the internal reference pulse with the synchronization signal and correcting the internal reference pulse by an amount of the error.

In accordance with another aspect of the present invention, there is provided a method for synchronizing time of an apparatus for wireless communication, comprising the steps of: receiving a synchronization signal and time information from a global position system; inputting of a set value for setting daylight-saving time and a Greenwich Mean Time offset; correcting an internal reference pulse compared with the synchronization signal; creating a data packet including an internal time information created by using the time information and the set value, and transforming the data packet into a data stream in accordance with timing of the internal reference pulse; and wirelessly transmitting the data stream.

In an exemplary embodiment of the present invention, in the receiving step, the synchronization signal and time information is received from the global navigation satellite system periodically, and in the creating step, the time information is set to the internal time information if the time information and the internal time information, which is created by increasing the time information to a fixed size, are repeatedly same for a fixed number of times when compared with each other.

In an exemplary embodiment of the present invention, the data packet includes a main time packet, a date packet, a clock adjust pending packet and a time offset packet, wherein, in the transforming step, the data packet is transformed into the data stream by allocating a slot every time offset packet, in which a message ID of the time offset packet is divided by a predetermined figure so that quotient and remainder are obtained, a slot to be filled with the time offset packet is allocated in accordance with a value of the quotient, and a position where the time offset packet is to be located after the clock adjust pending packet is determined in order of a value of the remainder.

In an exemplary embodiment of the present invention, in the creating step, the internal time information is created by applying a leap second if the set value further includes leap second information.

In an exemplary embodiment of the present invention, the method further comprising: receiving the time information with a wired connection, wherein, in the receiving step, the time information is received with the wired connection when the time information cannot be received wirelessly.

In an exemplary embodiment of the present invention, in the transforming step, the internal reference pulse is corrected by repeatedly performing a procedure of calculating an error by comparing the internal reference pulse with the synchronization signal and a procedure of correcting the internal reference pulse by an amount of the error.

In accordance with another aspect of the present invention, there is provided an apparatus for wireless communication, comprising: a receiving unit for receiving a radio signal, demodulating the radio signal into a data stream, and extracting a data packet from the data stream; a processor for correcting a time synchronization pulse generated by a internal counter/timer with timing of receiving the data packet, and extracting time information, leap second information and daylight saving time information from the data packet; and a clock for reflecting the leap second information and the daylight saving time in time gotten from the extracted time information, and displaying the time.

In an exemplary embodiment of the present invention, the data packet includes a message ID, and the receiving unit extracts the data packet from the data stream if a group ID of the apparatus and the message ID are same.

In an exemplary embodiment of the present invention, the apparatus further comprising: a real time clock generator for generating a time synchronization pulse, wherein the processor corrects the time synchronization pulse generated by the real time clock generator by comparing the time synchronization pulse generated by the real time clock generator with the timing and correcting a counter/timer of the real time clock generator.

In an exemplary embodiment of the present invention, the processor corrects the time synchronization pulse generated by the real time clock generator by accumulating an error of frequency between the time synchronization pulse generated by the real time clock generator and the timing and correcting the counter/timer of the real time clock generator by an integer value of the accumulated error of the frequency if a value of the accumulated error of the frequency exceeds one.

In an exemplary embodiment of the present invention, the processor controls the clock to display time in accordance with the time information included in the data packet received consequently three times if the time, in accordance with the time information included in the data packet received consequently three times, and time, in accordance with a internal clock, are same.

In an exemplary embodiment of the present invention, the apparatus further comprising: a buzzer for informing a user when a battery voltage is below a fixed voltage or a receiving channel is found.

In accordance with another aspect of the present invention, there is provided a method for synchronizing time of an apparatus for wireless communication, comprising the step of: receiving a radio signal, demodulating the radio signal into a data stream, and extracting a data packet from the data stream; generating a time synchronized pulse; correcting a time synchronization pulse generated by a internal counter/timer with timing of receiving the data packet, and extracting time information, leap second information and daylight saving time information from the data packet; and reflecting the leap second information and the daylight saving time in time gotten from the extracted time information, and displaying the time.

In an exemplary embodiment of the present invention, the data packet includes a message ID, wherein, in the extracting step, the data packet is extracted from the data stream if a group ID of the apparatus and the message ID are same.

In an exemplary embodiment of the present invention, the method further comprising: generating a time synchronization pulse with a real time clock generator, wherein, in the correcting step, the time synchronization pulse generated from the real time clock generator is corrected by comparing the time synchronization pulse generated from the real time clock generator with the timing and correcting a counter/timer of the real time clock generator.

In an exemplary embodiment of the present invention, in correcting step, the time synchronization pulse generated from the real time clock generator is corrected by accumulating an error of frequency between the time synchronization pulse generated by the real time clock generator and the timing, and by correcting the counter/timer of the real time clock generator by an integer value of the accumulated error of the frequency if a value of the accumulated error of the frequency exceeds one.

In an exemplary embodiment of the present invention, in the displaying step, time is displayed in accordance with the time information included in the data packet received consequently three times when the time in accordance with the time information included in the data packet received consequently three times is identical to time of an internal clock.

In an exemplary embodiment of the present invention, the method further comprising: informing a user when a battery voltage is below a fixed voltage or a receiving channel is found.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the configuration of a wireless time transmission/reception system according to an exemplary embodiment of the present invention;

FIG. 2 is a block diagram illustrating the configuration of a wireless time transmission apparatus according to an exemplary embodiment of the present invention;

FIG. 3 is a view illustrating a signal transmitted from a time reception apparatus;

FIG. 4A is a block diagram explaining a frequency correction method performed by the wireless time transmission apparatus;

FIG. 4B is a view showing an example where a frequency of the wireless time transmission apparatus is corrected;

FIG. 5 is a flowchart illustrating a time synchronization method performed by the wireless time transmission apparatus;

FIG. 6 is a view illustrating a format of a packet transmitted from the wireless time transmission apparatus;

FIG. 7 is a view illustrating a format of a packet transmitted every second;

FIG. 8 is a view illustrating a case of slotting packets, which are to be transmitted, in units of minutes;

FIG. 9 is a block diagram illustrating the configuration of a wireless time display apparatus according to an exemplary embodiment of the present invention;

FIG. 10 is a flowchart illustrating a frequency correction method performed by the wireless time display apparatus;

FIG. 11 is a graph conceptually illustrating a result of the frequency compensation performed by the wireless time display apparatus;

FIG. 12 is a flowchart illustrating a receiving-unit time synchronization method performed by the wireless time display apparatus; and

FIG. 13 is a block diagram illustrating the configuration of a wireless time transmission apparatus without a separate signal processor.

### DETAILED DESCRIPTION OF THE EXEMPLARY EMBODIMENTS

Hereinafter, an exemplary embodiment of the present invention will be described with reference to the accompanying drawings. It is to be noted that the same elements are indicated with the same reference numerals throughout the drawings. In the following description, a detailed description of known functions and configurations incorporated herein will be omitted when it may obscure the subject matter of the present invention.

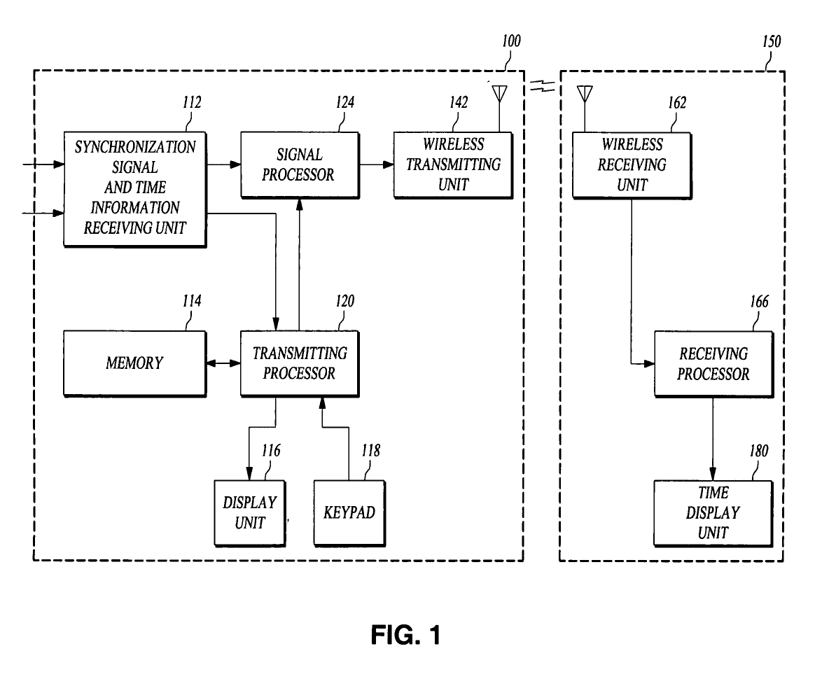

FIG. 1 is a block diagram illustrating the configuration of a wireless time transmission/reception system according to an exemplary embodiment of the present invention.

The wireless time transmission/reception system includes a wireless time transmission apparatus 100 and a wireless time display apparatus 150.

The wireless time transmission apparatus 100 includes a synchronization signal and time information receiving unit 112, a memory 114, a display unit 116, a keypad 118, a transmitting processor 120, a signal processor 124, and a wireless transmitting unit 142. The wireless time display apparatus 150 includes a wireless receiving unit 162, a receiving processor 166, and a time display unit 180.

The synchronization signal and time information receiving unit 112 receives a synchronization signal and time of day (TOD) information, transmits the synchronization signal to the signal processor 124, and transmits the TOD to the transmitting processor 120.

The keypad 118 receives set values, such as wireless transmission On/Off, application/release time points of daylight-saving time, a Greenwich Mean Time (GMT) offset, a communication speed, a transmission channel, and a network parameter, and the display unit 116 displays the current time, a leap second application time point, and the set values.

Meanwhile, the transmitting processor 120 creates a time packet by combining the TOD and the set values, and transmits the time packet to the signal processor 124.

The signal processor 124 creates an internal reference pulse by receiving and correcting the synchronization signal, transforms the time packet input from the transmitting processor 120 into a data stream in accordance with timing of the internal reference pulse, and transmits the data stream to the wireless transmitting unit 142. The wireless transmitting unit 142 transmits the data stream in the form of a radio frequency (RF) signal.

In addition, the frequency correction task for a synchronization signal and the conversion task into a data stream are performed by the signal processor 124 instead of the transmitting processor 120, and the transmitting processor 120 takes charge of processing only TOD, so that it is possible to reduce the load of the transmitting processor 120. Therefore, in generating an internal reference pulse within the wireless time display apparatus 150, although a synchronization signal is input at the moment the transmitting processor 120 is overloaded, time error due to the overload of the transmitting processor 120 is minimized because the synchronization signal is processed wholly by the signal processor 124.

Meanwhile, the wireless receiving unit 162 of the wireless time display apparatus 150 demodulates a received RF signal to create a time packet, and transmits the time packet to the receiving processor 166. The receiving processor 166 creates a time synchronization pulse by correcting the frequency of a pulse created by a counter/timer within the receiving processor 166 in accordance with a reception time of a main time packet transmitted at every exact second, while decoding a time packet and sending a time synchronization pulse and time information to the time display unit 180 (wherein, “the exact second” refers to every second on second, that is, a second on time, which has no value after the decimal point, such as a time point at ten minutes and fifteen seconds past ten o'clock, May 5, 2007).

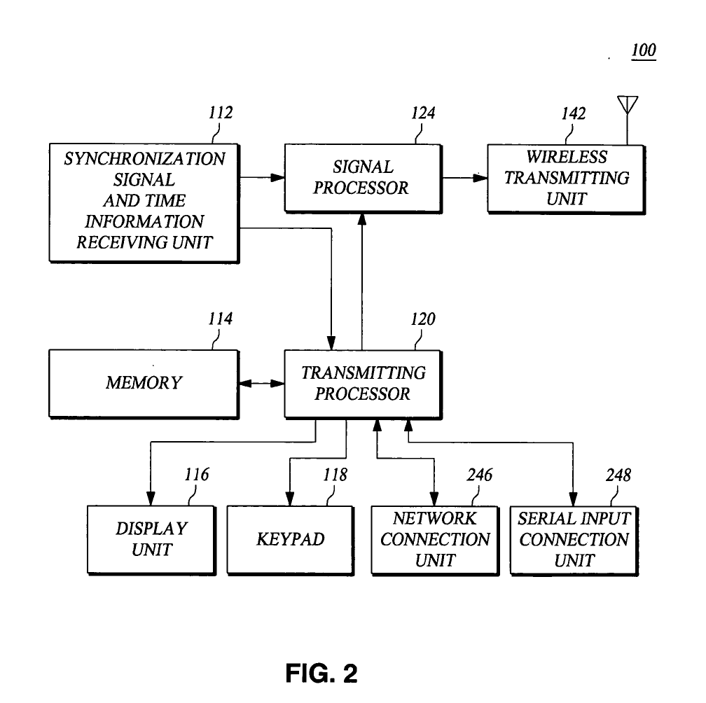

FIG. 2 is a block diagram illustrating the configuration of the wireless time transmission apparatus 100 according to an exemplary embodiment of the present invention.

The wireless time transmission apparatus 100 according to an exemplary embodiment of the present invention includes the synchronization signal and time information receiving unit 112, the memory 114, the display unit 116, the keypad 118, the signal processor 124, the transmitting processor 120, the wireless transmitting unit 142, a network connection unit 246, and a serial input connection unit 248.

The display unit 116 displays a state of a time reception apparatus (not shown), the current time (i.e. various time implemented by software, for example, Korean time, USA Pacific time, USA Eastern time, Paris, France time, etc.), daylight-saving time application/release time points, and various current-time-related set values including a GMT offset or the like. In addition, the display unit 116 displays a leap second application time point, a communication speed setting, a transmission channel setting, a setting related to an address of a network connection unit, etc. All setting parameters are input by the operation of the front keypad 118. All the setting parameters may be remotely set in such a manner to input desired values through a monitor connected to the network connection unit 246 or the serial input connection unit 248. In remotely setting, transmission time and information representing that remote operation is in progress are displayed on the display unit 116. Also, for system security, the front keypad operation and remote operation may be set to be available only after a preset password has been input.

The time reception apparatus (not shown) receives an RF signal including a synchronization signal and time information from a GNSS (i.e. a satellite navigation signal, such as a GPS, a GLONASS, a GALILEO, etc.), a long-wave time transmission signal (e.g. WWVB, JJY, CDF77, etc.), and so on, separates the time information and the synchronization signal from the RF signal, and transmits the time information and the synchronization signal to the wireless time transmission apparatus 100.

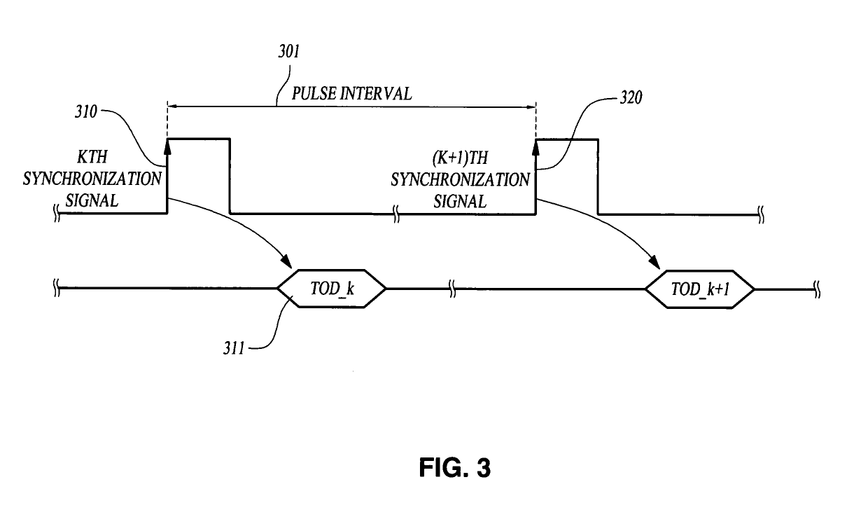

FIG. 3 is a view illustrating a signal transmitted from the time reception apparatus (not shown).

In FIG. 3, a pulse interval 301 generally is one second, but may have a value other than one second according to circumstances. The time of a rising edge 310 of a k^{th} synchronization signal is included in a TOD_k 311 and is transmitted.

A synchronization signal, which the synchronization signal and time information receiving unit 112 has received from the time reception apparatus (not shown), is input to a timer logic configured by the signal processor 124, and TOD is input to the transmitting processor 120 through data input connection such as a universal asynchronous receiver/transmitter (UART) or the like.

The signal processor 124 receives the synchronization signal, creates an internal reference pulse by performing a frequency correction on the synchronization signal, transforms a time packet input from the transmitting processor into a data stream in accordance with timing of the created internal reference pulse, and transmits the data stream to the wireless transmitting unit 142.

Information transmitted to the wireless transmitting unit 142 is transmitted as data in the form of packets, differently from the output form of the time reception apparatus (not shown), wherein the transmitted packet includes time information and a plurality of parameters.

The synchronization signal is periodically input, and generally has a period of one second. The synchronization signal is created using a signal generated from a very accurate frequency source. A Global Positioning System (GPS) most widely used as a time source generally shows a very high accuracy of an error of 1 μs or less, as compared to a Universal Time Coordinated (UTC), even though there is some difference between products.

Meanwhile, when the wireless time transmission apparatus 100 cannot receive TOD from the time reception apparatus (not shown), the wireless time transmission apparatus 100 may receive TOD with a wired connection using a network protocol, such as an SNTP or IEEE 1588, through the network connection unit 246.

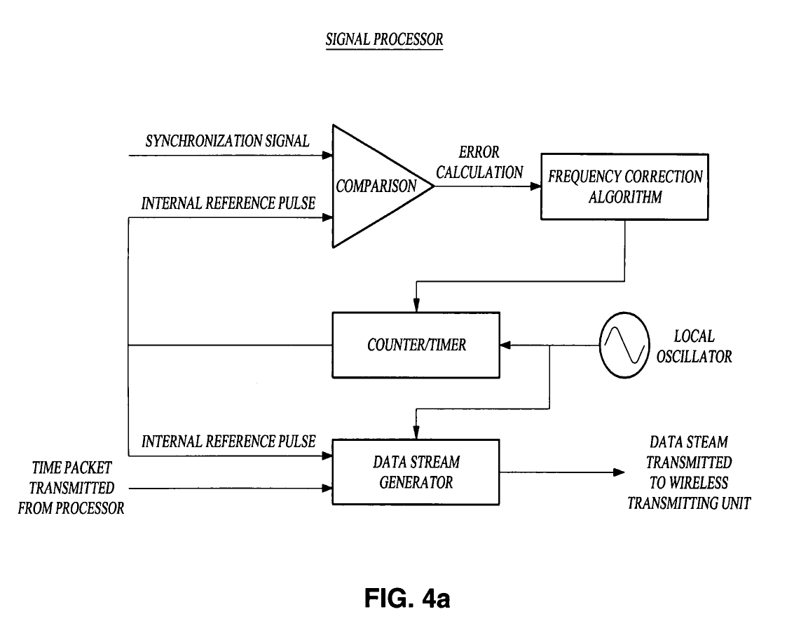

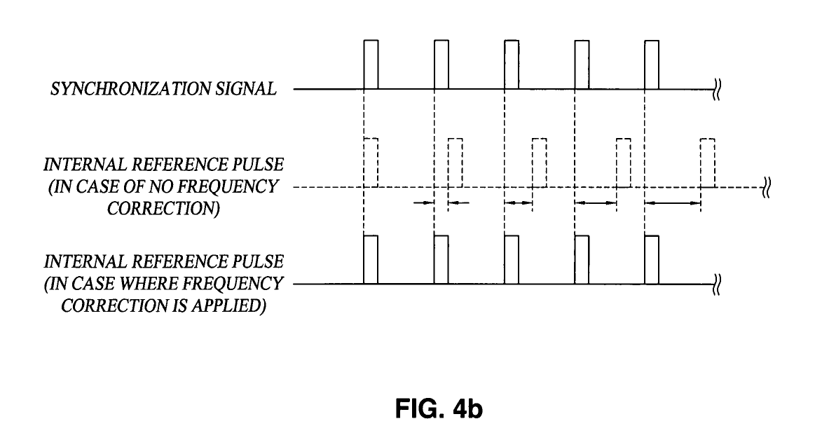

When the counter/timer of the signal processor 124 has been set to create a pulse in accordance with timing of the synchronization signal, it is possible to consecutively create a pulse at the same location if there is no error in the frequency of a local oscillator. However, if an error is caused in the frequency, errors are accumulated as time goes by, and an error of pulse generation time increases. Generally, in the case of low-priced local oscillators, they have errors of several tens to several hundreds of ppm according to their types. For example, when a clock has been made with a local oscillator having an error of about 50 ppm, an error of one second per about 5.6 hours is caused. A radio controlled clock (RCC; a clock receiving a long wave, such as WWVB, JJY, DCF77, etc.), which is commercially sold, receives a synchronization signal only about two times per day, and synchronizes time in order to minimize power consumption. However, it can be easily observed that errors of several seconds occur between clocks due to inaccuracy of their local oscillators. For this reason, the wireless time transmission apparatus 100 according to the present invention creates an internal reference pulse in accordance with the period of a synchronization signal through frequency correction, and continuously maintains the internal reference pulse, thereby minimizing an error in time, which may occur when the wireless time transmission apparatus 100 cannot receive a synchronization signal from the time reception apparatus (not shown). A frequency correction method will now be described in detail with reference to FIGS. 4A and 4B.

FIG. 4A is a block diagram explaining a frequency correction method performed by the wireless time transmission apparatus 100, and FIG. 4B is a view showing an example where a frequency of the wireless time transmission apparatus 100 is corrected.

As shown in FIGS. 4A and 4B, when an internal reference pulse is created by a local oscillator and a counter/timer of the signal processor 124, the counter/timer is adjusted so that an error between the created internal reference pulse and an input synchronization signal is nearly zero. Most internal reference pulses, created in such a manner, cause jitters according to the resolutions of counters/timers used upon frequency correction.

According to an exemplary embodiment of the present invention, as the frequency of a local oscillator increases, a jitter decreases in proportion to the frequency. For example, when a frequency of 10 MHz and a corresponding counter are used, a jitter of about 100 ns which is one period of the 10 MHz frequency occurs, and when a frequency of 100 MHz and a corresponding counter are used, a jitter of about 10 ns, which is one period of the 100 MHz frequency, occurs.

Since the wireless time transmission apparatus 100 generally performs a transmission operation every second, a constant correction is performed by comparing a synchronization signal and an internal reference pulse every second. If it is impossible to receive a synchronization signal from the time reception apparatus (not shown), the current frequency of a local oscillator is estimated and controlled by making reference to an existing correction history. For example, when a frequency of 10 MHz is used and a control of subtracting a frequency value corresponding to one period of 10 MHz from the 10 MHz frequency once every ten seconds after the first synchronization has been performed, a set value of a counter creating a one-second pulse once every ten seconds is determined to be 9,999,999. Since most oscillators' frequencies are changed depending on ambient temperature, measuring temperature makes it possible to perform a more accurate control.

When the wireless time transmission apparatus 100 creates a time packet, internal time is created in such a manner as to increase TOD acquired from an external time source every second, based on a corrected internal reference pulse. When the time corresponds to a UTC based on the local time at the Royal Observatory, Greenwich, in England, software-based time is created by taking into consideration a GMT offset from the local time at the Royal Observatory, Greenwich, in England, and time is created by taking daylight-saving time into consideration if the daylight-saving time is applied to the area where the system according to the present invention operates.

In order to maintain and transfer various local times in the whole word by taking into consideration a GMT offset, daylight-saving time, etc., the present invention provides a transmitting-unit time synchronization method.

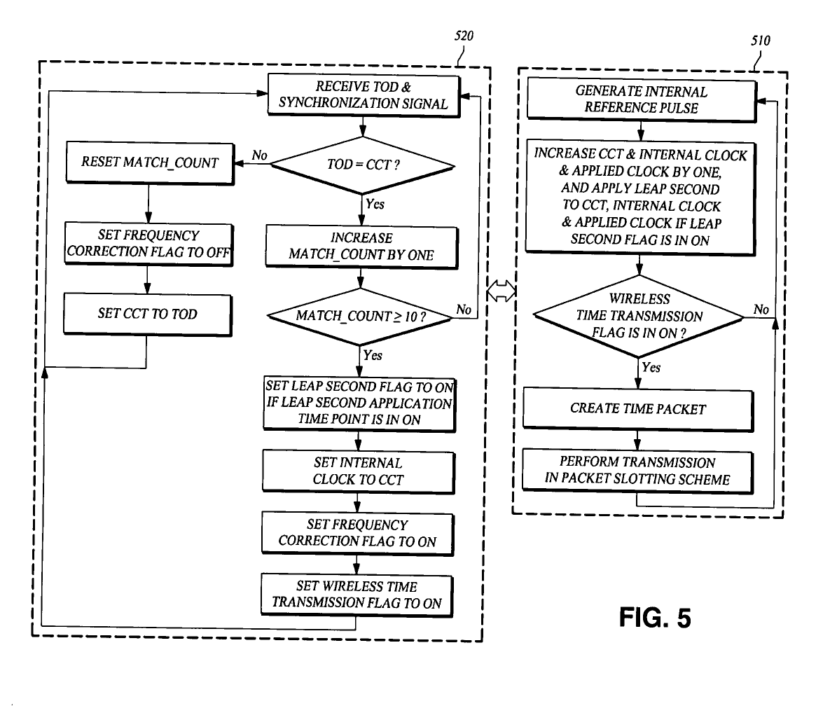

FIG. 5 is a flowchart illustrating the transmitting-unit time synchronization method performed by the wireless time transmission apparatus 100.

In FIG. 5, a time packet transmission flow 510 and a transmitting-unit time synchronization flow 520 operate in parallel, and affect each other. That is, the time packet transmission flow 510 performs a task of maintaining a comparison clock (CCT), an internal clock, and an applied clock based on an internal reference pulse (where the transmitting-unit time synchronization flow 520 is influenced by changed values of the CCT and internal clock), identifies a wireless time transmission flag turned-on by the transmitting-unit time synchronization flow 520, and transmits a time packet. Also, the transmitting-unit time synchronization flow 520 verifies whether or not a received TOD value is appropriate by using a CCT value created by the time packet transmission flow 510.

As shown in the transmitting-unit time synchronization flow 520 of FIG. 5, when TOD(k) is input from the time reception apparatus (not shown) at a specific time “k,” the TOD(k) is compared with a CCT based on the counter/timer of the signal processor 124. When the TOD(k) is not equal to the CCT as a result of the comparison, the CCT is set to the input TOD(k).

At the next second “t(k+1), that is, at one second after the specific time “k,” when TOD(k+1) is input from the time reception apparatus (not shown), the TOD(k+1) is compared with the CCT. If the TOD(k+1) corresponds to a monotonic increase, which is normally generated, the TOD(k+1) is equal to the CCT. When the TOD(k+1) is equal to the CCT as a result of the comparison, the value of “match_count” increases by one. In contrast, when the TOD(k+1) is not equal to the CCT as a result of the comparison, the “match_count” is cleared, it is determined that the reliability of the input synchronization signal is low, and a flag is turned off so as to prevent frequency correction from being performed. In the state where the “match_count” has a value of ten or more, when a leap second application time point is in an ON state, a leap second flag is turned on, the internal clock is set to a CCT value, a frequency correction flag is turned ON so as to start frequency correction, and a wireless time transmission flag is turned ON so that a time packet can be generated and transmitted to the wireless time display apparatus.

Thereafter, the value of the internal clock increases based on an internal reference pulse created by the frequency correction. In this case, the applied clock operates by software so as to display local times of various areas through the display unit 116, and simultaneously to transmit related information. A plurality of times can be simultaneously operated as far as the capability of the used transmitting processor allows. To the respective times, mutually different GMT offsets and daylight-saving times may be applied. However, since the leap second is applied to correct an error based on the revolution of the earth, the leap second is applied to all internal time data at the same time.

As shown in the time packet transmission flow 510 of FIG. 5, when an internal reference pulse is created, the respective values of the CCT, internal clock, and applied clock is increased by one second, wherein if the leap second flag is in an ON state, the leap second is applied to the CCT, internal clock, and applied clock. In this case, when the wireless time transmission flag is in an ON state, a time packet is generated and transmitted in a packet slotting scheme.

Among time data created in this case, only time of “applied clock_1,” which is a main transmission time, is transmitted through a main time packet, and times of the remaining “applied clock_2,” “applied clock_3,”, “applied clock_2,” are transmitted only for relative GMT offsets and daylight-saving time application/release information. The packet of the “applied clock_1,” which is the main transmission time, is transmitted to the signal processor 124 at an exact second, that is, at a second on time, which has no value after the decimal point.

When the wireless time transmission apparatus performs time synchronization through an SNTP or IEEE 1588 because it cannot acquire time information from the time reception apparatus (not shown), it is possible to obtain a UTC (GMT offset=0) capable of achieving synchronization within a range from a few ms to a few tens of ms, although the accuracy of the time synchronization is lower than the case where a dedicated time reception apparatus (not shown) is used. Accordingly, an internal clock to which the UTC is applied, and applied clocks, to which GMT offsets and daylight-saving times are applied according to application areas, are created.

Also, the wireless time transmission apparatus 100 has a packet slotting structure to implement a packet structure for efficient packet transmission and to efficiently transmit global time.

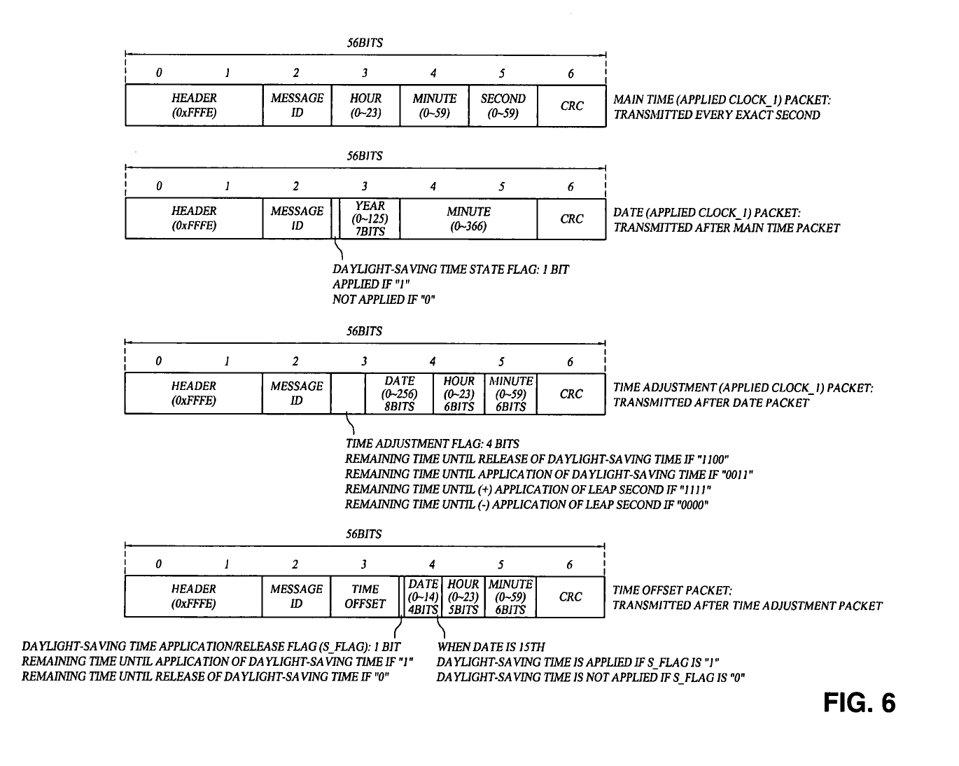

FIG. 6 is a view illustrating a format of a packet transmitted from the wireless time transmission apparatus 100.

As understood in FIG. 6, a main time packet, a date packet, and a clock adjust pending packet are transmitted in order, and then a time offset packet distinguished by a message ID is transmitted.

As shown in FIG. 6, the main time packet may be set to include local time of an area where the wireless time transmission apparatus 100 is located, the date packet may be set to include date information about the area where the wireless time transmission apparatus 100 is located, and the clock adjust pending packet may be set to include daylight-saving time information and leap second information about the area where the wireless time transmission apparatus 100 is located.

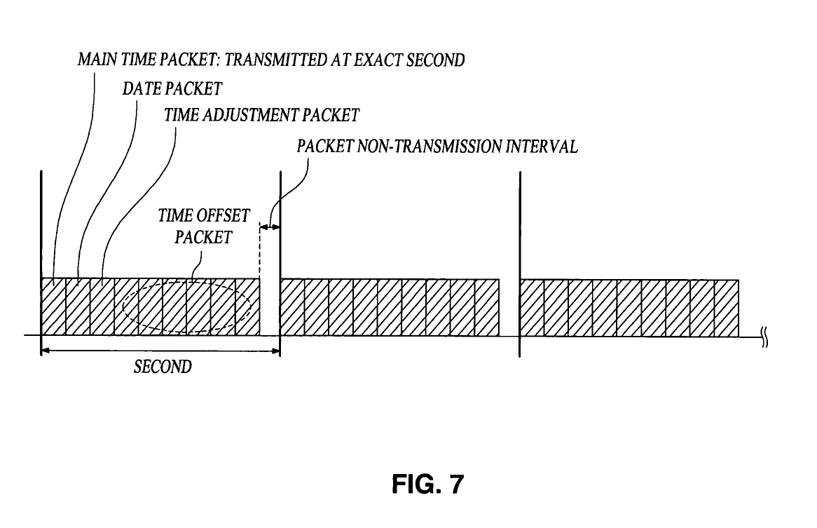

FIG. 7 is a view illustrating a format of a packet transmitted every second.

Packets have the same size of 7 bytes. At a data rate of 550 bps, a maximum of nine packets per second can be transmitted as shown in FIG. 7. That is, six time offset packets, except for three packets allocated to a main time packet, a date packet, and a clock adjust pending packet, can be transmitted every second.

When world times are subdivided in units of fifteen minutes, the calculation results are that times of ±96 levels are required based on an applied clock_1, which is a main transmission time, though actual world time is subdivided into more detailed levels. Since times of ±60 levels are enough to represent principal cities of principal countries, the following description will be given about a case, for the convenience of calculation, where 120 kinds of message IDs are allocated to time offset packets, and transmission/reception time is allocated to a quotient and a remainder, which are obtained by dividing the message ID of each time offset packet by six.

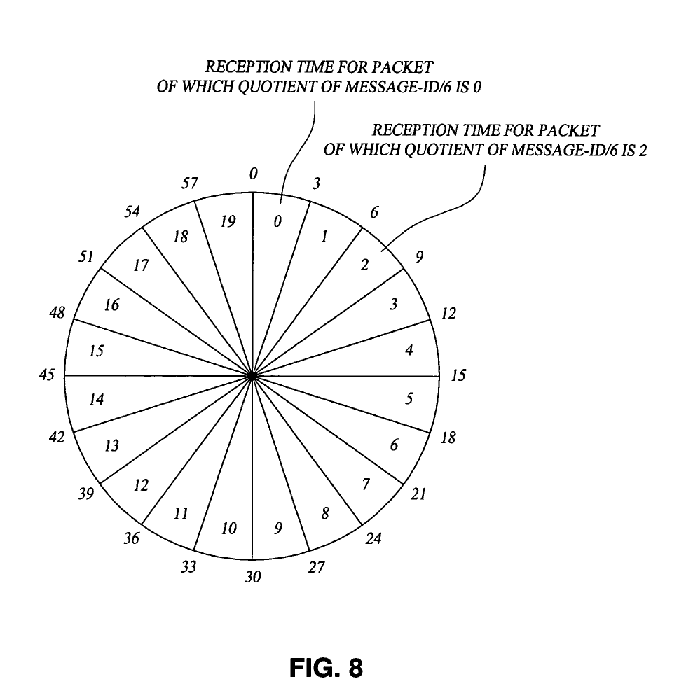

FIG. 8 is a view illustrating a case of slotting packets, which are to be transmitted, in units of minutes.

As shown in FIG. 8, a slot to transmit each time offset packet is determined according to a quotient obtained by dividing the message ID of the time offset packet by six, wherein the slot corresponds to a value within a range from 0 to 19, and covers one minute. A data packet is positioned in the first slot when a quotient obtained by dividing a corresponding message ID by six is zero, in the second slot when a quotient is one, and in the eighth slot when a quotient is seven. In addition, message IDs having a value in a range from zero to five as a remainder when the respective message IDs are divided by six, can be used to consecutively transmit six time offset packets, as shown in FIG. 7, so that a total of 120 message IDs can be used.

The position of each time offset packet within an allocated slot is determined according to a remainder obtained by dividing each message ID by six. That is, in order of the values of remainders, a time offset packet is located in the first position after a clock adjust pending packet when the value of a remainder is zero, in the second position when the value of a remainder is one, and in the sixth position when the value of a remainder is five. Accordingly, since a slot interval is three seconds, time offset packets of an equal message ID are consecutively transmitted three times for three seconds.

When a device control instruction based on transmission time is required in addition to time display, it can be easily achieved in such a manner as to allocate packets for time display to even-numbered message IDs, and to allocate packets for control to odd-numbered message IDs.

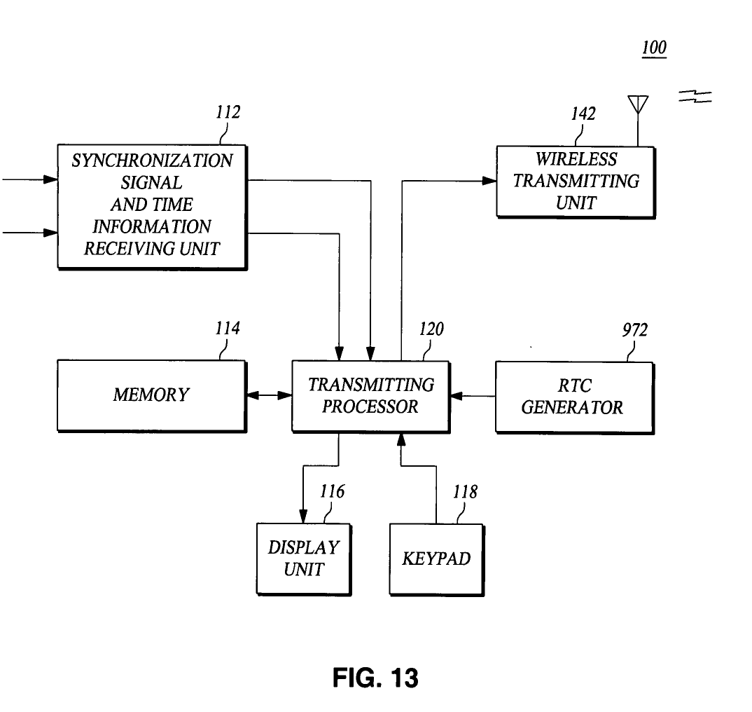

FIG. 13 is a block diagram illustrating the configuration of a wireless time transmission apparatus without a separate signal processor. As shown in FIG. 13, the wireless time transmission apparatus 100 may be constituted by the synchronization signal and time information receiving unit 112, the memory 114, the display unit 116, the keypad 118, an RTC generator 972, the transmitting processor 120, and the wireless transmitting unit 142.

Since the wireless time transmission apparatus 100 of FIG. 13 is constituted without a signal processor, differently from the wireless time transmission apparatus shown in FIG. 1, the task performed by the signal processor is shared by the RTC generator and the transmitting processor. That is, the RTC generator includes a counter/timer to generate and transmit a pulse to the transmitting processor, while the synchronization signal and time information receiving unit receives a synchronization signal and TOD, demodulates the received signal into a bit stream, and transmits the bit stream to the transmitting processor. The transmitting processor creates an internal reference pulse by correcting the frequency of the pulse, which has been transmitted from the RTC generator, in accordance with the synchronization signal received from the synchronization signal and time information receiving unit. In addition, the transmitting processor performs even tasks of transforming a time packet into a data stream in accordance with timing of the generated internal reference pulse, and transmitting the data stream to the wireless transmitting unit 142.

Also, a wireless time transmission apparatus may be constituted by a synchronization signal and time information receiving unit, a memory, a display unit, a keypad, a transmitting processor, and a wireless transmitting unit. Such a wireless time transmission apparatus is implemented without the RTC generator among the components of the wireless time transmission apparatus shown in FIG. 13, and has a difference in that the transmitting processor is charged with the whole task performed by the signal processor, as compared with the wireless time transmission apparatus shown in FIG. 1. That is, the transmitting processor performs a task of receiving a bit stream, which is obtained by receiving and demodulating a synchronization signal and TOD by the synchronization signal and time information receiving unit. In addition, a pulse generated by the counter/timer in the transmitting processor is used even when an internal reference pulse is created by performing a frequency correction on a received synchronization signal, and also the transmitting processor performs tasks of transforming a time packet into a data stream in accordance with timing of the generated internal reference pulse, and transmitting the data stream to the wireless transmitting unit.

Although wireless time transmission apparatuses may be implemented in various manners as described above, the wireless time transmission apparatus having a separate signal processor, as shown in FIG. 1, has the best performance in accuracy of time at which a time packet is transmitted. In contrast, in the case of a wireless time transmission apparatus having neither a separate signal processor nor a separate RTC generator, the transmitting processor must perform not only tasks of pulse generation, synchronization signal frequency correction, and time packet creation, but also a task of transmitting a time packet to the wireless transmitting unit, so that the possibility of time delay is high due to the overhead of the transmitting processor, thereby providing the lowest accuracy.

Meanwhile, the wireless time display apparatus 150 receives a time packet transmitted from the wireless time transmission apparatus 100, and displays a time.

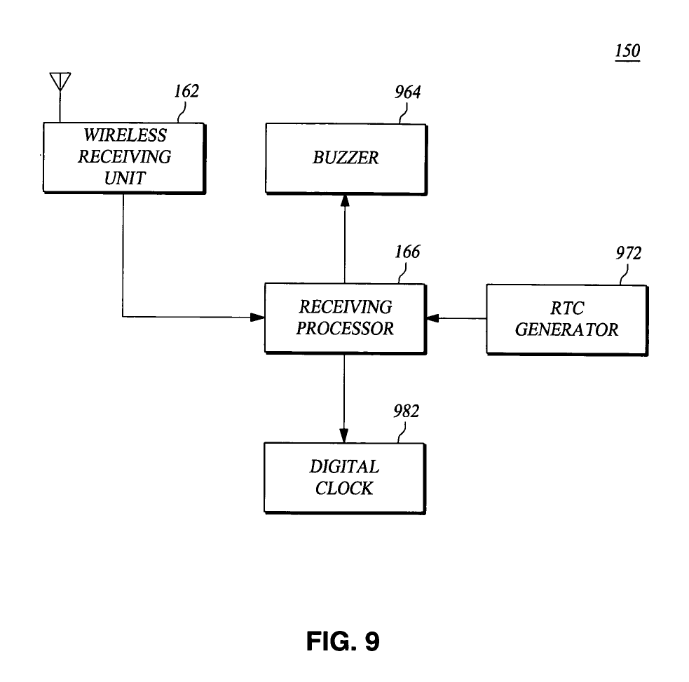

FIG. 9 is a block diagram illustrating the configuration of the wireless time display apparatus 150 according to an exemplary embodiment of the present invention.

The wireless time display apparatus 150 according to an exemplary embodiment of the present invention includes a wireless receiving unit 162, a receiving processor 166, a buzzer 964, an RTC generator 972, and a digital clock 982.

As soon as the wireless time display apparatus 150 is powered on, the wireless receiving unit 162 attempts to acquire an RF signal through each receivable channel, and receives an RF signal when a receiving channel is found.

The wireless receiving unit 162 demodulates the received RF signal to a bit stream, extracts a time packet from the bit stream, and outputs the time packet to the receiving processor 166. The receiving processor 166 performs a synchronization operation to create a time synchronization pulse by using the received time packet.

Meanwhile, when a receiving channel has been set by the wireless receiving unit 162, the wireless time display apparatus 150 notifies the user, through the buzzer 964, that the receiving channel has been set.

While the wireless receiving unit 162 searches channels, a sound is generated through the buzzer 964 in order to notify the user of a channel change. Also, even when a channel has been successfully found, the buzzer 964 is used to notify the user that the channel has been found. In order to easily distinguish these sounds from each other, a beep sound is generated one time whenever a channel change is performed, while the beep sound is consequently generated two times when a channel has been successfully found.

In addition, when it is time to replace batteries for the wireless time display apparatus 150 (i.e. when the battery voltage is at a predetermined voltage level or lower), the beep sound is consequently generated four times in a period of one minute. In this case, the wireless receiving unit 162 stops receiving an RF signal in order to minimize power consumption of the battery.

According to embodiments of the present invention, the wireless time display apparatus 150 may be implemented to receive only a main time packet in addition to a time offset packet as data packets, may be implemented to receive only a main time packet and a date packet in addition to a time offset packet as data packets, or may be implemented to receive a main time packet, a date packet, and a clock adjust pending packet, in addition to a time offset packet as data packets. For example, when the wireless time display apparatus 150 uses an analog clock of a simple form, the date information is not required.

In order to receive time information transmitted in the packet slotting scheme by the wireless time transmission apparatus 100, a group ID (GID) is allocated to the wireless time display apparatus 150, and the receiving processor 166 extracts packet information only when a message ID of a transmitted time packet is identical to the group ID.

The wireless time display apparatus 150 receives an applied clock_1, which is a main transmission time, at an appointed time, and attempts to receive a time (i.e. a time slot) pre-allocated to its own group based on the applied clock_1. The wireless receiving unit 162 operates only during a required time period through the reception time slotting group by group (i.e. GID by GID), as described above, until receiving a packet for a group (GID) to which the wireless time display apparatus 150 belongs, so that it is possible to reduce power consumption.

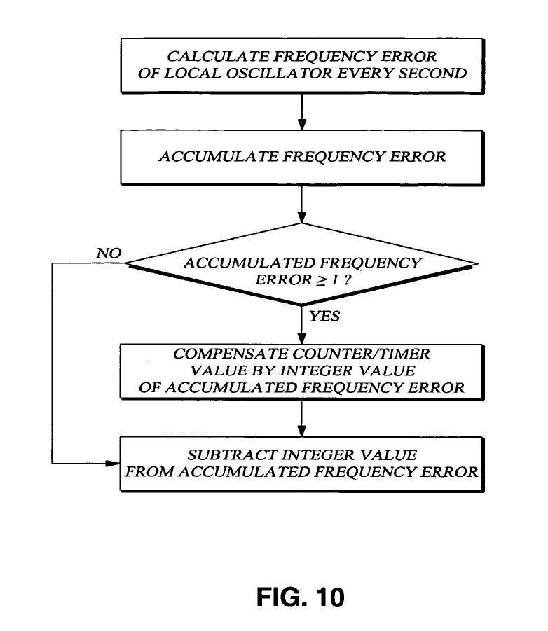

Also, in order to minimize an error in time even if a signal is not transmitted from the wireless time transmission apparatus 100, the receiving processor 166 performs a frequency correction by adjusting the counter/timer of the RTC generator 972 as much as an error of a time synchronization pulse generated by the counter/timer based on timing of a main time packet received at an exact second, thereby maintaining time synchronization pulses with improved accuracy. Meanwhile, the wireless time display apparatus 150 maintains a software-type internal clock by using time information, which is extracted from a time packet in accordance with a corrected time synchronization pulse, and the time of the maintained internal clock may be displayed through the digital clock 982. FIG. 10 is a flowchart illustrating a frequency correction method performed by the wireless time display apparatus.

As shown in FIG. 10, frequency errors of a local oscillator are calculated every second, and are then accumulated. When the accumulated frequency error value exceeds one, a frequency correction is performed by compensating the value of the counter/timer as much as an integer value of the accumulated frequency error value.

Generally, the wireless time display apparatus 150 using battery power receives a time signal two times to four times per day in order to reduce power consumption. If a local oscillator (not shown) using a clock has an accuracy of about +10 ppm, the local oscillator gains 0.216 second during 6 hours, and 0.432 second during 12 hours.

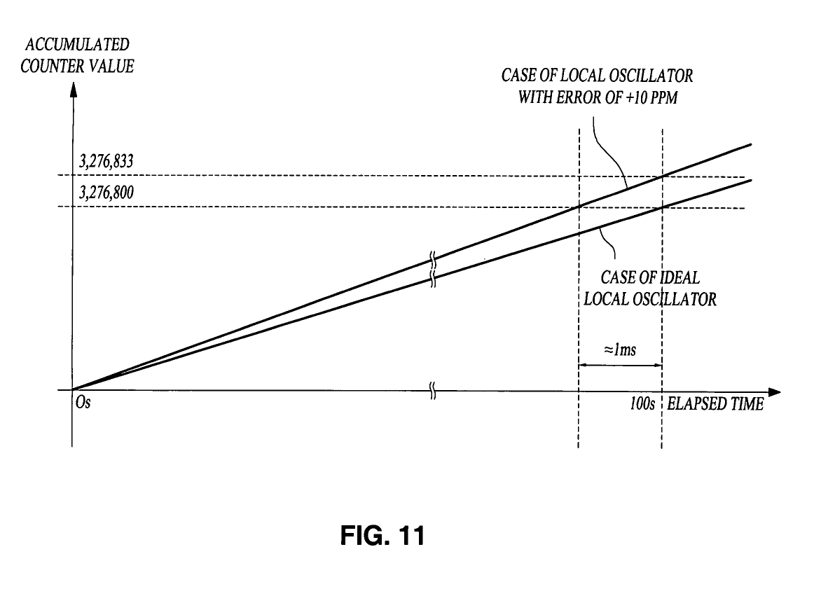

For example, it can be understood that when a time synchronization is attempted four hours after the first synchronization in a power-on state, an error of 0.144 second occurs. If the wireless time display apparatus 150 uses a crystal oscillator of 32.768 kHz as a local oscillator (not shown), and dispenses the output of the crystal oscillator to the counter/timer of the RTC generator 972, it is necessary to compensate for “10 ppm×32768 Hz=0.32768 Hz” every second. Since the minimum unit of the compensation using the counter/timer is 1 Hz, an approximate compensation is possible by periodically performing the compensation instead of performing the compensation every second. That is, when the compensation is performed in units of 100 seconds, a method of adding “0.32768×100=32.769-33 pulses” to the value of the counter/timer in a period of 100 seconds may be used. FIG. 11 is a graph conceptually illustrating a result of the frequency compensation performed by the wireless time display apparatus 150.

As shown in FIG. 11, in the case of using a 32,768 Hz oscillator with an error of +10 ppm, when the counter value becomes 3,276,800, the oscillator gains an error of about 1 ms, as compared with an ideal case where an oscillator without error is used as the local oscillator. In order to compensate for such an error, it is possible to do an approximate compensation by setting a time point of 100 seconds to be when the count value is 3,276,833.

In the case of a frequency compensation for a clock viewed by people, increasing the counter value by 33 counts every 100 seconds may serve as a sufficient compensation. In the case of a device necessitating a more detailed time, a method of compensating the counter value by one count every three seconds (where errors due to environments and device characteristics, such as temperature change and aging are excluded) may be used, thereby minimizing a time error every second.

According to the frequency compensation method, when a compensation value calculated for frequency error is less than one, calculated compensation values are continuously accumulated every second. When the accumulated value exceeds one, an integer value of the accumulated value is compensated for, and following calculated compensation values are accumulatively added to the remainder thereof until an accumulated value exceeds one and the next compensation is performed.

When synchronization of a time synchronization pulse is finished, a found channel is stored in the receiving processor 166 so that a channel search can be omitted until another time synchronization pulse is received at the next appointed time. If a transmission channel of the wireless time transmission apparatus 100 is changed, a channel search is automatically performed to find another channel because it is impossible to receive signals through a channel stored in the wireless time display apparatus 150. The wireless receiving unit 162 is constructed in such a manner as to be supplied with power only during a required period of time, so that it is possible to reduce power consumption.

Although a time synchronization pulse synchronized through reception of an RF signal may be maintained by the counter/timer of the receiving processor 166, the method according to an exemplary embodiment of the present invention maintains the time synchronization pulse by using the counter/timer of the RTC generator 972 in order to improve the reliability of the time synchronization pulse.

A bit stream (i.e. data packet) input from the wireless receiving unit 162 to the receiving processor 166 is decoded and is divided into TOD and other time information (e.g. a leap second, daylight-saving time, a time offset according to each message ID, and daylight-saving time according to each message ID) in the receiving processor 166. In this case, since time information of an equal message ID can be transmitted consecutively at least three times, when information identical to an internal clock is received three times or more, it is determined that there is no error, and the internal clock is used.

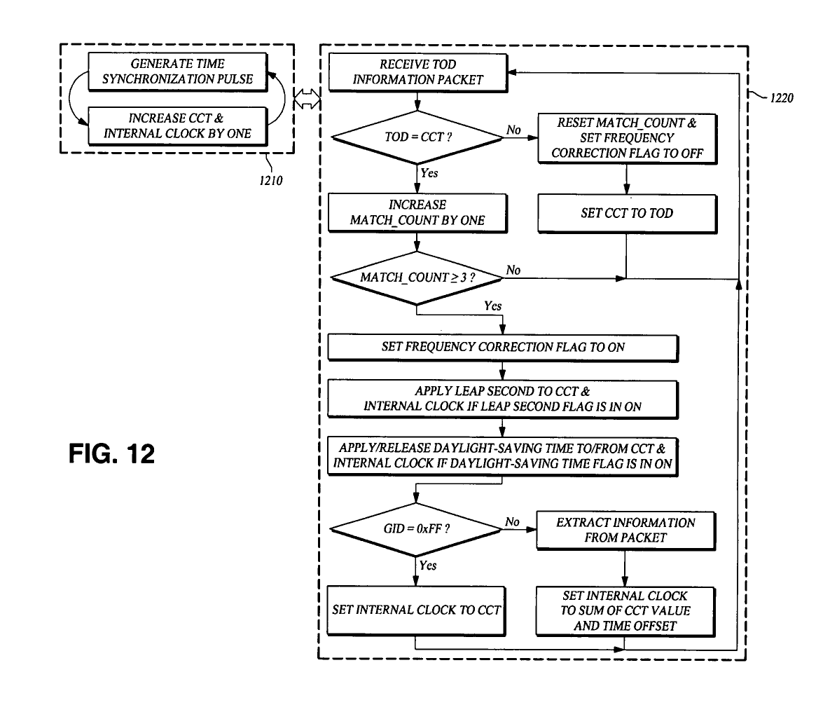

FIG. 12 is a flowchart illustrating a receiving-unit time synchronization method performed by the wireless time display apparatus 150.

In FIG. 12, a synchronization pulse generation flow 1210 and a receiving time synchronization flow 1220 operate in parallel, and affect each other. That is, the synchronization pulse generation flow 1210 performs a task of maintaining a comparison clock (CCT) and an internal clock based on a time synchronization pulse, and a receiving time synchronization task using the values of the CCT and internal clock, which are created through the synchronization pulse generation flow 1210.

As shown in FIG. 12, when TOD(k) is received together with a time synchronization pulse at a specific time “k,” the TOD(k) is compared with CCT based on the counter/timer of the RTC generator 972. When the TOD(k) is not equal to the CCT as a result of the comparison, a match_count is cleared, and the CCT is set to the input TOD(k) after an operation of turning off the frequency correction flag is performed because it is determined that the reliability of the input time synchronization pulse is low.

In contrast, when the TOD(k) is equal to the CCT as a result of the comparison, the match_count increases. Further, when the TOD(k) matches with the CCT three times or more, the input time synchronization pulse is determined to have a high reliability, and the frequency correction flag is turned on so that a frequency correction can start. In this case, when the leap second flag or the daylight-saving time flag is in an ON state, the leap second or the daylight-saving time is reflected in the internal clock and the CCT.

When a group ID (GID, which corresponds to a message ID of a transmitted packet) set in the wireless time display apparatus 150 is “0xFF,” that is, when the apparatus uses a main transmission time, the internal clock is set to a CCT value, and a corresponding time is displayed through the digital clock 982. In this case, the apparatus may be constructed to ignore a time offset packet, to receive only a main time packet, and to display a time.

If the GID is not “0xFF,” time-related information is collected from a packet slot determined according to a corresponding GID of the wireless time display apparatus 150, and the internal clock is set to a sum of a CCT value and a time offset so as to display a time through the digital clock 982.

In the case of a digital clock, since there are no hands requiring arrangement, it can be easily implemented, and A.M/P.M., year/month/day, etc. are displayed case by case. Since the wireless time transmission apparatus 100 transmits only the information about a year and how many days have elapsed after the year starts, a leap year, a day of the week, etc. are calculated according to known formulas by the digital clock 982, and are displayed.

In the case where the time display unit 180 corresponds to an analog clock, when the receiving processor 166 sends a time pulse, the analog clock decodes the time pulse to display a time.

As described above, according to the wireless time transmission/reception system and the time synchronization method of the present invention, an apparatus for receiving time information provided from various wired/wireless time sources and wirelessly transmitting the time information, and an apparatus for receiving the transmitted time information perform a frequency correction together with a time correction. Thus, when the wireless time transmission apparatus does not receive a synchronization signal and time information by intention or unavoidably, a frequency correction is performed, thereby improving accuracy of time. In addition, the wireless time transmission apparatus processes a synchronization signal by means of a signal processor dedicated for synchronization signal processing, thereby minimizing an error in time.

Also, in the wireless time display apparatus, inaccuracy of time due to inaccuracy of the frequency of the local oscillator is mended by applying a frequency correction algorithm.

In addition, according to the present invention, parts requiring a large amount of power consumption and complex configuration are concentrated on one apparatus, i.e., on the wireless time transmission apparatus, and a plurality of wireless time display apparatuses, such as a clock, are configured by simpler hardware, thereby solving the complexity of the receiver.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention has been described not for limiting the scope of the invention, but for describing the invention. Accordingly, the scope of the invention is not to be limited by the above embodiment but by the claims and the equivalents thereof. Accordingly, the scope of the invention should be determined by the following claims and their legal equivalents.

What is claimed is:

1. An apparatus for wireless communication, comprising:
a receiving unit for wirelessly receiving a synchronization signal and time information from a global navigation satellite system;
an input unit for input of a set value for setting daylight-saving time and a Greenwich Mean Time offset;
a memory for storing the time information and the set value;
a processor for correcting an internal reference pulse compared with the synchronization signal, creating a data packet including an internal time information created using the time information and the set value, and transforming the data packet into a data stream in accordance with timing of the internal reference pulse; and
a transmitting unit for wirelessly transmitting the data stream.

2. The apparatus as claimed in claim 1, wherein the receiving unit wirelessly receives the synchronization signal and the time information from the global navigation satellite system periodically, and the processor sets the time information as the internal time information if the time information and the internal time information, which is created by increasing the time information to a fixed size, are repeatedly same for a fixed number of times when compared with each other.

3. The apparatus as claimed in claim 2, wherein the data packet includes a main time packet, a date packet, a clock adjust pending packet and a time offset packet, and the processor transforms the data packet into the data stream allocating a slot to every time offset packet, in which the processor divides a message ID of the time offset packet by a predetermined figure so that gets quotient and remainder, allocates the slot which is to be filled with the time offset packet in order of a value of the quotient, and determines where the time offset packet is located after the clock adjust pending packet in order of a value of the remainder.

4. The apparatus as claimed in claim 1, wherein the processor creates the internal time information by applying a leap second if the set value further includes leap second information.

5. The apparatus as claimed in claim 1, further comprising:
a network connection unit for receiving the time information with a wired connection, wherein the processor controls the network connection unit to receive the time information with the wired connection if the receiving unit is not capable of wirelessly receiving the time information.

6. The apparatus as claimed in claim 1, wherein the processor includes a transmitting processor and a signal processor, in which the signal processor corrects the internal reference pulse, and the transmitting processor creates the data packet and transforms the data packet into the data stream.

7. The apparatus as claimed in claim 6, wherein the signal processor corrects the internal reference pulse by repeatedly calculating an error by comparing the internal reference pulse with the synchronization signal and correcting the internal reference pulse by an amount of the error.

8. A method for synchronizing time of an apparatus for wireless communication, comprising the steps of:
receiving a synchronization signal and time information from a global position system;
inputting of a set value for setting daylight-saving time and a Greenwich Mean Time offset;
correcting an internal reference pulse compared with the synchronization signal;
creating a data packet including an internal time information created by using the time information and the set value, and transforming the data packet into a data stream in accordance with timing of the internal reference pulse; and
wirelessly transmitting the data stream.

9. The method as claimed in claim 8, wherein, in the receiving step, the synchronization signal and time information is received from the global navigation satellite system periodically, and in the creating step, the time information is set to the internal time information if the time information and the internal time information, which is created by increasing the time information to a fixed size, are repeatedly same for a fixed number of times when compared with each other.

10. The method as claimed in claim 9, wherein the data packet includes a main time packet, a date packet, a clock adjust pending packet and a time offset packet, wherein, in the transforming step, the data packet is transformed into the data stream by allocating a slot every time offset packet, in which a message ID of the time offset packet is divided by a predetermined figure so that quotient and remainder are obtained, a slot to be filled with the time offset packet is allocated in accordance with a value of the quotient, and a position where the time offset packet is to be located after the clock adjust pending packet is determined in order of a value of the remainder.

11. The method as claimed in claim 8, wherein, in the creating step, the internal time information is created by applying a leap second if the set value further includes leap second information.

12. The method as claimed in claim 8, further comprising:
receiving the time information with a wired connection, wherein, in the receiving step, the time information is received with the wired connection when the time information cannot be received wirelessly.

13. The method as claimed in claim 8, wherein, in the transforming step, the internal reference pulse is corrected by repeatedly performing a procedure of calculating an error by comparing the internal reference pulse with the synchronization signal and a procedure of correcting the internal reference pulse by an amount of the error.

14. An apparatus for wireless communication, comprising:
a receiving unit for receiving a radio signal, demodulating the radio signal into a data stream, and extracting a data packet from the data stream;
a processor for correcting a time synchronization pulse generated by a internal counter/timer with timing of receiving the data packet, and extracting time information, leap second information and daylight saving time information from the data packet; and
a clock for reflecting the leap second information and the daylight saving time in time gotten from the extracted time information, and displaying the time.

15. The apparatus as claimed in claim 14, wherein the data packet includes a message ID, and the receiving unit extracts the data packet from the data stream if a group ID of the apparatus and the message ID are same.

16. The apparatus as claimed in claim 14, further comprising:
a real time clock generator for generating a time synchronization pulse, wherein the processor corrects the time synchronization pulse generated by the real time clock generator by comparing the time synchronization pulse generated by the real time clock generator with the timing and correcting a counter/timer of the real time clock generator.

17. The apparatus as claimed in claim 16, wherein the processor corrects the time synchronization pulse generated by the real time clock generator by accumulating an error of frequency between the time synchronization pulse generated by the real time clock generator and the timing and correcting the counter/timer of the real time clock generator by an integer value of the accumulated error of the frequency if a value of the accumulated error of the frequency exceeds one.

18. The apparatus as claimed in claim 14, wherein the processor controls the clock to display time in accordance with the time information included in the data packet received consequently three times if the time, in accordance with the time information included in the data packet received consequently three times, and time, in accordance with a internal clock, are same.

19. The apparatus as claimed in claim 14, further comprising:
a buzzer for informing a user when a battery voltage is below a fixed voltage or a receiving channel is found.

20. A method for synchronizing time of an apparatus for wireless communication, comprising the step of:
receiving a radio signal, demodulating the radio signal into a data stream, and extracting a data packet from the data stream;
generating a time synchronized pulse;
correcting a time synchronization pulse generated by a internal counter/timer with timing of receiving the data packet, and extracting time information, leap second information and daylight saving time information from the data packet; and
reflecting the leap second information and the daylight saving time in time gotten from the extracted time information, and displaying the time.

21. The method as claimed in claim 20, wherein the data packet includes a message ID, wherein, in the extracting step, the data packet is extracted from the data stream if a group ID of the apparatus and the message ID are same.

22. The method as claimed in claim 20, further comprising:
generating a time synchronization pulse with a real time clock generator, wherein, in the correcting step, the time synchronization pulse generated from the real time clock generator is corrected by comparing the time synchronization pulse generated from the real time clock generator with the timing and correcting a counter/timer of the real time clock generator.

23. The method as claimed in claim 22, wherein, in correcting step, the time synchronization pulse generated from the real time clock generator is corrected by accumulating an error of frequency between the time synchronization pulse generated by the real time clock generator and the timing, and by correcting the counter/timer of the real time clock generator by an integer value of the accumulated error of the frequency if a value of the accumulated error of the frequency exceeds one.

24. The method as claimed in claim 20, wherein, in the displaying step, time is displayed in accordance with the time information included in the data packet received consequently three times when the time in accordance with the time information included in the data packet received consequently three times is identical to time of an internal clock.

25. The method as claimed in claim 14, further comprising:
informing a user when a battery voltage is below a fixed voltage or a receiving channel is found.
